(19) United States
(12) Patent Application Publication
(10) Pub. No.: US 2026/0052447 A1
(43) Pub. Date: Feb. 19, 2026

(54) Generation and Transmission of Measurement Configuration and Related Condition Configuration

(71) Applicant: Telefonaktiebolaget LM Ericsson (publ), Stockholm (SE)

(72) Inventors: Cecilia Eklöf, Täby (SE); Alessio Terzani, Stockholm (SE); Jens Bergqvist, Linköping (SE); Icaro Leonardo Da Silva, Stockholm (SE)

(21) Appl. No.: 19/101,638

(22) PCT Filed: Aug. 4, 2023
(86) PCT No.: PCT/SE2023/050780

§ 371 Date: Feb. 6, 2025

Related U.S. Application Data
(60) Provisional application No. 63/370,795, filed on Aug. 9, 2022.

(51) Int. Cl. H04W 36/36; H04W 36/00

(52) U.S. Cl. CPC H04W 36/362; H04W 36/00835

(57) ABSTRACT

A method performed by a second network node (13) for handling communication of a UE (10), in a communication network (1). The second network node (13) generates a measurement configuration and a related condition configuration. The second network node (13) transmits to a first network node (12) and/or the UE (10), an indication of the 5 generated measurement configuration and/or the related condition configuration.

### TECHNICAL FIELD

Embodiments herein relate to a second network node, a first network node, a user equipment (UE) and methods performed therein regarding communication. Furthermore, a computer program product and a computer-readable storage medium are also provided herein. In particular, embodiments herein relate to handling communication, such as handling or controlling cell configurations, in a communication network.

### BACKGROUND

In a typical communication network, UEs, also known as wireless communication devices, mobile stations, stations (STA) and/or wireless devices, servers, computers, communicate via an Access Network (AN), such as a radio access network (RAN) or a wired access network, with one or more core networks (CNs). The AN covers a geographical area which is divided into service areas or cells, with each service area or cell being served by a network node such as an access node e.g. a Wi-Fi access point or a radio base station (RBS), which in some networks may also be called, for example, a NodeB, a gNodeB, or an eNodeB. The service area or cell is a geographical area where radio coverage is provided by the network node. The network node operates on radio frequencies to communicate over an air interface with the UEs within range of the access node. The network node communicates over a downlink (DL) to the UE and the UE communicates over an uplink (UL) to the access node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate, e.g., enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises, and coordinates various activities of the plural radio network nodes connected thereto. The RNCs are typically connected to one or more core networks.

Specifications for the Evolved Packet System (EPS) have been completed within the 3GPP and present and coming 3GPP releases, such as New Radio (NR) and extensions, are being worked on. The EPS comprises of the Evolved Universal Terrestrial Radio Access Network (E-UTRAN), also known as the Long-Term Evolution (LTE) radio access network, and the Evolved Packet Core (EPC), also known as the System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies such as new radio (NR), the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

### 3GPP Dual Connectivity.

In 3GPP Rel-12, the LTE feature Dual Connectivity (DC) was introduced, to enable the UE to be connected in two cell groups, each controlled by an LTE access node, such as eNBs, labelled as the Master eNB (MeNB) and the Secondary eNB (SeNB). The UE still only has one RRC connection with the network. In 3GPP, the Dual Connectivity (DC) solution has since then evolved and is now also specified for NR as well as between LTE and NR. Multi-connectivity (MC) is the case when there are more than 2 nodes involved. With introduction of 5G, the term Multi-Radio Dual Connectivity (MR-DC), see also 3GPP TS 37.340 v. 17.0.0, was defined as a generic term for all dual connectivity options which includes at least one NR access node. Using the MR-DC generalized terminology, the UE is connected in a Master Cell Group (MCG), controlled by the Master Node (MN), and in a Secondary Cell Group (SCG) controlled by a Secondary Node (SN).

Further, in MR-DC, when dual connectivity is configured for the UE, within each of the two cell groups, MCG and SCG, carrier aggregation may be used as well. In this case, within the MCG controlled by the MN, the UE may use one primary cell (PCell) and one or more secondary cells (SCell). And within the SCG controlled by the SN, the UE may use one Primary SCell (PSCell), also known as the primary SCG cell in NR, and one or more SCell(s). This combined case is illustrated in FIG. 1. In NR, the primary cell of a master or secondary cell group is sometimes also referred to as the Special Cell (SpCell). Hence, the SpCell in the MCG is the PCell and the SpCell in the SCG is the PSCell.

FIG. 1 is an illustration of dual connectivity combined with carrier aggregation in MR-DC.

There are different ways to deploy 5G network with or without interworking with LTE, also referred to as E-UTRA, and evolved packet core (EPC). In principle, NR and LTE can be deployed without any interworking, denoted by NR stand-alone (SA) operation, that is a gNB in NR can be connected to 5G core network (5GC), called option 2. An eNB in LTE can be connected to EPC with no interconnection between the two, called option 1.

On the other hand, the first supported version of NR uses dual connectivity, denoted as E-UTRAN-NR Dual Connectivity (EN-DC), also known as Option 3, as depicted in FIG. 2. In such a deployment, dual connectivity between NR and LTE is applied, where the UE is connected with both the LTE radio interface, interface LTE Uu in the FIG. 2, to an LTE access node and the NR radio interface, interface NR Uu in the FIG. 2, to an NR access node. Further, in EN-DC, the LTE access node acts as the master node, in this case known as the Master eNB, MeNB, controlling the MCG, and the NR access node acts as the secondary node, in this case sometimes also known as the Secondary gNB, SgNB, controlling the SCG. The SgNB may not have a control plane (C-plane) connection to the core network (EPC) which instead is provided by MeNB and in this case provided by the NR. This is also called as “Non-standalone NR” or, in short, “NSA NR”. Notice that in this case the functionality of an NR cell is limited and would be used for connected mode UEs as a booster and/or diversity leg, but an RRC_IDLE UE cannot camp on these NR cells.

With introduction of 5GC, other options may be also valid. As mentioned above, option 2 supports stand-alone NR deployment where gNB is connected to the 5GC. Similarly, LTE can also be connected to the 5GC using option 5, also known as eLTE, E-UTRA/5GC, or LTE/5GC and the node can be referred to as an ng-eNB. In these cases, both NR and LTE are seen as part of the NG-RAN, and both the ng-eNB and the gNB can be referred to as NG-RAN nodes.

It is worth noting that there are also other variants of dual connectivity between LTE and NR which have been standardized as part of NG-RAN connected to 5GC. Under the MR-DC umbrella there are:
EN-DC (Option 3): LTE is the master node and NR is the secondary node (EPC CN employed, as depicted in FIG. 2)
NE-DC (Option 4): NR is the master node and LTE is the secondary (5GCN employed)
NGEN-DC (Option 7): LTE is the master node and NR is the secondary (5GCN employed)
NR-DC (variant of Option 2): Dual connectivity where both the MN, controlling the MCG, and the SN, controlling the SCG, are NR (5GCN employed, as depicted in FIG. 3).

FIG. 3 shows NR-DC.

### Conditional Handover (CHO).

In 3GPP Rel-16, the conditional handover was standardized as a solution to increase the robustness at handover. In order to avoid the undesired dependence on the serving radio link upon the time, and radio conditions, where the UE should execute the handover, it was standardized the possibility to provide radio resource control (RRC) signalling for the handover to the UE earlier. It is possible to associate the handover (HO) command with a condition, e.g., based on radio conditions possibly similar to the ones associated to an A3 event, where a given neighbour becomes X dB better than target. As soon as the condition is fulfilled, the UE executes the handover in accordance with the provided HO command.

Such a condition could, e.g., be that the quality of the target cell or beam becomes X dB stronger than the serving cell. The threshold Y used in a preceding measurement reporting event should then be chosen lower than the one in the handover execution condition. This allows the serving cell to prepare the handover upon reception of an early measurement report and to provide the RRCConnectionReconfiguration with mobilityControlInfo, or the RRCReconfiguration with reconfigurationWithSync, at a time when the radio link between the source cell and the UE is still stable. The execution of the handover is done at a later point in time, and threshold, which is considered optimal for the handover execution.

FIG. 4 shows a conditional handover execution.

FIG. 4 depicts an example with just a serving cell and a target cell. In practice there may often be many cells or beams that the UE reported as possible candidates based on its preceding radio resource management (RRM) measurements. The network should then have the freedom to issue CHO commands for several of those candidates. The RRCConnectionReconfiguration/RRCReconfiguration message for each of those candidates may differ not just concerning the target cell but also, e.g., in terms of the HO execution condition, e.g., reference signal (RS) to measure and threshold to exceed, as well as in terms of the random access (RA) preamble to be sent when a condition is met.
1. While the UE evaluates the condition, it continues operating per its current RRC configuration, i.e., without applying the CHO command. When the UE determines that the condition is fulfilled, it disconnects from the serving cell, applies the CHO command and connects to the target cell. These steps are equivalent to the legacy handover execution.
2. When the UE has successfully performed the RA procedure towards the target cell during a CHO or a normal HO, it then releases all the conditional reconfigurations that it has stored. The target cell may then configure new conditional reconfigurations to the UE if it is considered useful.

### Conditional PSCell Change (CPC) in 3GPP Rel-16.

A solution for CPC procedure was also standardized in Rel-16. Therein a UE operating in MR-DC receives in a conditional reconfiguration one or multiple RRC Reconfiguration(s), e.g., an RRCReconfiguration message, containing an SCG configuration, e.g., a secondaryCellGroup of IE CellGroupConfig, with a reconfigurationWithSync that is stored and associated to an execution condition, e.g., a condition like an A3/A5 event configuration, so that one of the stored messages is only applied upon the fulfillment of the execution condition, e.g., associated with the serving PSCell, upon which the UE would perform PSCell change, in case it finds a neighbour cell that is better than the current SpCell of the SCG. Only intra-SN CPC without MN involvement is standardized in 3GPP Rel-16, i.e., for cases where the, candidate or, target PSCells are located in the current serving SN.

Similar to CHO, in case an RA was performed for a target PSCell and the UE was configured with CPC, the UE then releases all the conditional reconfigurations that it has stored.

Conditional PSCell Addition (CPA) and inter-SN CPC in 3GPP Rel-17.

In 3GPP Rel-17 solutions for CPA and inter-SN CPC are being discussed and introduced. The CPA procedure is used for adding a PSCell/SCG to the configuration for a UE that is currently only configured with an MCG, when associated execution conditions are fulfilled. CPA is initiated by the MN by requesting an SCG configuration, which is to be provided as part of a conditional reconfiguration to the UE, from a, candidate or, target SN (T-SN), and then sending it in a conditional reconfiguration to the UE together with the associated execution conditions.

The inter-SN CPC can be initiated either by the MN or by the source SN (S-SN), where the signalling towards the source SN and the, candidate or, target SNs, as well as towards the UE, in both cases is handled by the MN. One of the possible signalling sequences for configuration of an inter-SN CPC, which is initiated by the source SN, can be seen in the signaling flow in FIG. 5:

FIG. 5 shows Inter-SN CPC in 3GPP Rel-17.

Also, for Rel-17 CPC/CPA, it can be expected that the UE configured with CPC/CPA has to release the CPC/CPA configurations when completing RA towards the target PSCell.

NR-DC with selective activation of the cell groups (at least for SCG) via L3 enhancements in 3GPP Rel-18.

3GPP Rel-18 work is starting up to introduce enhancements for different mobility procedures, with a Work Item Description in RP-213565, New WI: Further NR mobility enhancements, MediaTek, 3GPP TSG RAN Meeting #94e, Dec. 6-17, 2021. One of the current objectives is “to specify mechanism and procedures of NR-DC with selective activation of the cell groups (at least for SCG) via L3 enhancements”, which includes “to allow subsequent cell group change after changing CG without reconfiguration and re-initiation of CPC/CPA”.

It should thus be possible to perform a subsequent cell group change after a first cell group change, without reconfiguring or re-initiation CPC or CPA. This would then be done in order to reduce the interruption time and the signalling overhead for SCG changes, especially in the case of frequent SCG changes when operating in FR2 in NR, compared to when these configurations are released when the UE completes RA towards the target PSCell, as in the previous releases.

### SUMMARY

As part of developing embodiments herein one or more problems were first identified. In 3GPP Rel-18, in order for a UE to perform subsequent cell group changes, without reconfiguration of CPC/CPA, one option is that the UE keeps stored, i.e., does not release, the conditional reconfigurations of the candidate target cells, e.g., CPC to a T-SN, after performing a mobility procedure. However, it is not clear how the measurement configurations and related execution conditions then would be handled. For instance, if the UE stores the execution conditions received from the S-SN and uses them for the evaluation of the conditional reconfigurations after it moves to the T-SN, such “old” execution conditions might not be valid anymore or might refer to wrong measurement configurations because they are generated by the previous SN. This can cause possible misconfiguration and wrong evaluation of the conditional reconfigurations.

An object herein is to provide a mechanism to handle communication efficiently in the communication network.

According to an aspect the object is achieved, according to embodiments herein, by providing a method performed by a second network node for handling communication of a UE in a communication network. The second network node generates measurement configuration and a related condition configuration. The second network node transmits to a first network node and/or the UE, an indication of the generated measurement configuration and/or the related condition configuration.

According to yet another aspect the object is achieved, according to embodiments herein, by providing a method performed by a UE for handling communication in a communication network. The UE receives an indication of a generated measurement configuration and/or a related condition configuration for a second network node.

According to an aspect the object is achieved, according to embodiments herein, by providing a method performed by a first network node for handling communication of a UE in a communication network. The first network node receives an indication of a generated measurement configuration and/or a related condition configuration for a UE in a cell of a second network node.

According to yet another aspect the object is achieved, according to embodiments herein, by providing a second network node for handling communication of a UE in a communication network. The second network node is configured to generate measurement configuration and a related condition configuration. The second network node is further configured to transmit to a first network node and/or the UE, an indication of the generated measurement configuration and/or the related condition configuration.

According to yet another aspect the object is achieved, according to embodiments herein, by providing a UE for handling communication in a communication network. The UE is configured to receive an indication of a generated measurement configuration and/or a related condition configuration for a second network node.

According to an aspect the object is achieved, according to embodiments herein, by providing a first network node for handling communication of a UE in a communication network. The first network node is configured to receive an indication of a generated measurement configuration and/or a related condition configuration for a UE in a cell of a second network node.

It is furthermore provided herein a computer program product comprising instructions, which, when executed on at least one processor, cause the at least one processor to carry out the methods herein, as performed by the first/second network node and the UE, respectively. It is additionally provided herein a computer-readable storage medium, having stored thereon a computer program product comprising instructions which, when executed on at least one processor, cause the at least one processor to carry out the methods herein, as performed by the first/second network node and the UE, respectively.

Embodiments herein include different methods to allow the UE to have the correct measurement configurations and, for example, execution conditions of a related condition configuration once the UE performs a mobility procedure, e.g., CPC to a T-SN, being an example of the second network node.

It is herein disclosed a possibility to update the measurement configurations and execution conditions of the related condition configuration when the UE moves to a candidate T-SN and keeps the conditional configuration of other candidate cells. Hence, embodiments herein make it possible for the UE to correctly evaluate the conditional configurations of the other candidate cells, since the UE has the correct measurement configurations and, for example, execution conditions after the UE has moved to a candidate T-SN. Thus, embodiments herein handle communication efficiently for UEs in the communication network.

### BRIEF DESCRIPTION OF THE DRAWINGS

Embodiments will now be described in more detail in relation to the enclosed drawings, in which:

FIG. 1 shows an architecture according to prior art;

FIG. 2 shows an architecture according to prior art;

FIG. 3 shows an architecture according to prior art;

FIG. 4 shows a signalling diagram according to prior art;

FIG. 5 shows a signalling diagram according to prior art;

FIG. 6 shows a communication network according to embodiments herein;

FIG. 7 shows a combined signalling scheme and flowchart according to embodiments herein;

FIG. 8a shows a combined signalling scheme and flowchart according to embodiments herein;

FIG. 8b shows a schematic overview depicting an architecture according to some embodiments herein;

FIG. 9 shows a flowchart depicting a method performed by a second network node according to embodiments herein;

FIG. 10 shows a flowchart depicting a method performed by a UE according to embodiments herein;

FIG. 11 shows a flowchart depicting a method performed by a first network node according to embodiments herein;

FIGS. 12a-12b show schematic overviews depicting a second network node according to embodiments herein;

FIGS. 13a-13b show schematic overviews depicting a UE according to embodiments herein;

FIGS. 14a-14b show schematic overviews depicting a first network node according to embodiments herein;

FIG. 15 schematically illustrates a telecommunication network connected via an intermediate network to a host computer;

FIG. 16 is a generalized block diagram of a host computer communicating via a base station with a user equipment over a partially wireless connection; and

FIGS. 17-20 are flowcharts illustrating methods implemented in a communication system including a host computer, a base station and a user equipment.

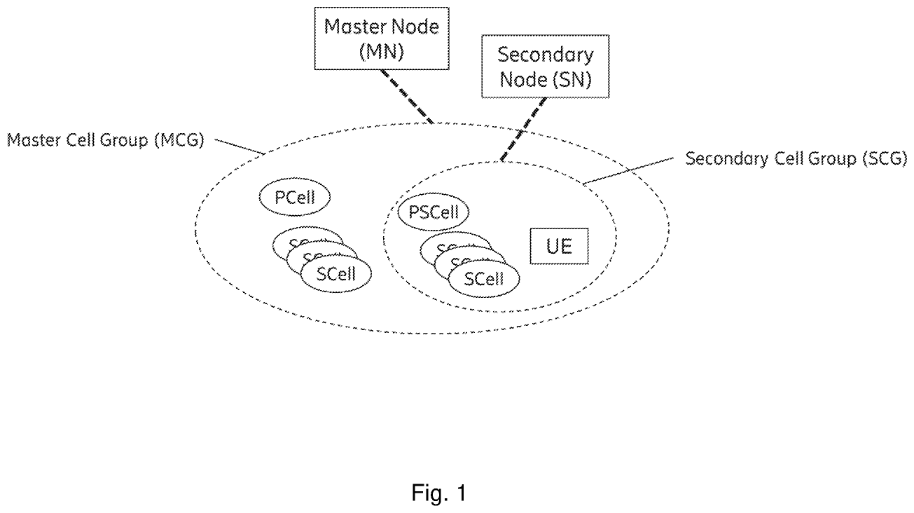

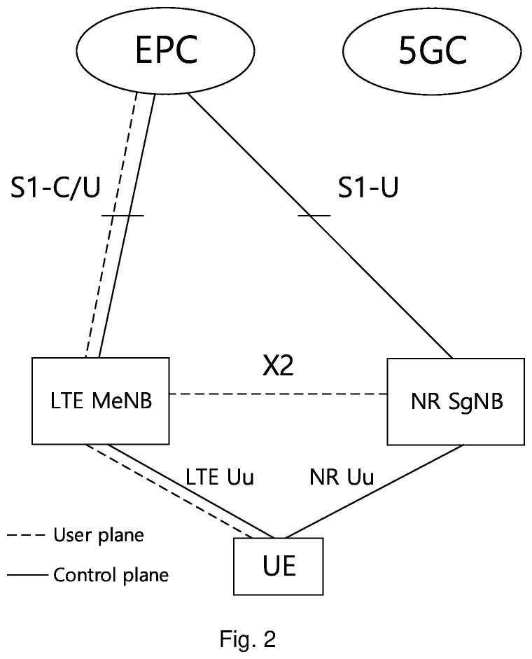

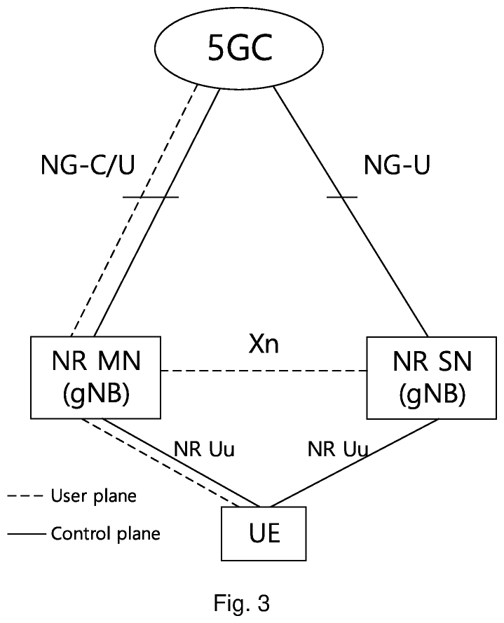

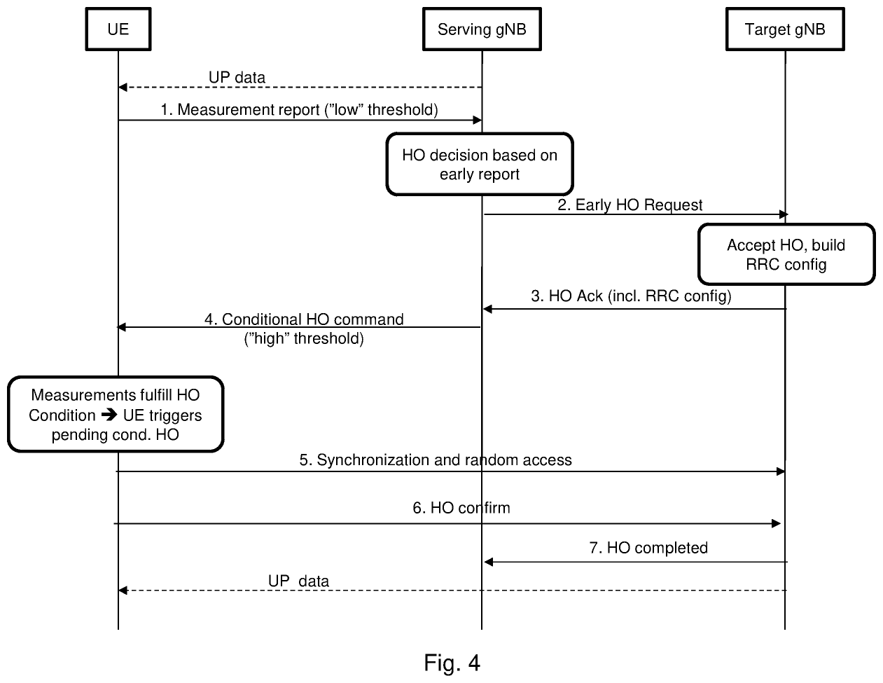

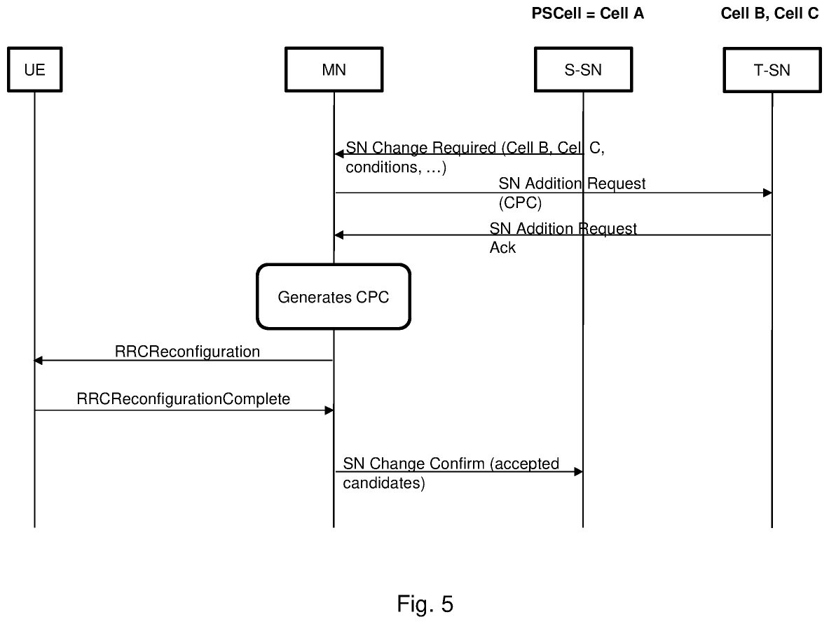

### DETAILED DESCRIPTION

Embodiments herein relate to communication networks in general. FIG. 6 is a schematic overview depicting a communication network 1. The communication network 1 comprises one or more ANs, such as RANs or wired ANs, and one or more CNs. The communication network 1 may use one or a number of different technologies. Embodiments herein relate to recent wired and wireless networks such as Wi-Fi, new radio (NR), other existing wired or wireless networks, and further developments of existing wireless communications systems such as e.g., LTE or WCDMA.

In the communication network 1, a UE 10, for example, a wireless device such as a mobile station, a non-access point (non-AP) station (STA), a STA and/or a wireless terminal, is comprised communicating via the one or more AN to other UEs or one or more CNs. It should be understood by the skilled in the art that “UE” is a non-limiting term which means any terminal, wireless communications terminal, internet of things (IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The communication network 1 comprises a first network node 12 providing radio coverage over a geographical area, a first service area 11 or first cell, of a first RAT, such as WiFi, NR, LTE, or similar. The network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a UE within the area served by the radio network node depending e.g. on the first radio access technology and terminology used. The first network node 12 may be an access node such as a WiFi-modem or a radio network node and may be referred to as a serving radio network node, master node, or serving secondary network node, wherein the service area may be referred to as a source cell. It should be noted that a service area may be denoted as cell, beam, beam group or similar to define an area of radio coverage.

The communication network 1 comprises a second network node 13 providing radio coverage over a geographical area, a secondary service area 14 or secondary cell, of a first/second RAT, such as WiFi, NR, LTE, or similar. The second network node 13 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a UE within the area served by the radio network node depending e.g. on the first radio access technology and terminology used. The secondary network node 13 may be an access node such as a WiFi-modem or a radio network node and may be referred to as a target secondary radio network node, candidate PSCell, or target network node, wherein the service area may be referred to as a target cell, candidate cell. It should be noted that a service area may be denoted as cell, beam, beam group or similar to define an area of radio coverage.

According to embodiments herein the second network node 13, such as a T-SN, generates measurement configuration and related condition configuration. The generated measurement configuration and related condition configuration may be a full set or a delta set of a complete measurement configuration and related condition configuration. The generated measurement configuration and/or related condition configuration is reported to the UE 10 and/or the first network node 12, such as a MN or a S-SN. The UE 10 may store the measurement configuration and related condition configuration for the candidate second network node 13. The UE 10 may transmit to the second network node 13, an indication of the stored measurement configuration and related condition configuration for the candidate second network node 13. The second network node 13 may check the received indication with its own measurement configuration and related condition configuration for the candidate second network node 13 and if needed update the measurement configuration and related condition configuration for the UE 10.

Embodiments herein include different methods to allow the UE to have the correct measurement configurations and, for example, execution conditions of a related condition configuration once the UE performs a mobility procedure, e.g., CPC to a T-SN, being an example of the second network node 13. This is based on the UE 10 receiving the updated measurement configurations from the T-SN(s) by means of one of the following:
Measurement configurations and/or execution conditions of a related condition configuration received before the mobility execution
   When the T-SN is added as candidate cell by the MN, such as in a S-NODE ADDITION REQUEST, the T-SN generates the SCG measConfig and execution conditions for each CPC candidate that will be kept by the UE. The measurement configurations can be a full or a delta configuration.
   The T-SN includes the SCG measConfig and/or execution conditions in the related condition configuration such as one or more conditional reconfigurations of the candidates, in for example, an RRCReconfiguration**, and these are sent to the MN, such as in a S-NODE ADDITION REQUEST ACK, and to the UE, such as in an RRCReconfiguration. The execution conditions that are provided may be associated to the one or more other conditional reconfiguration(s) that are kept after execution of this conditional reconfiguration.
      In one alternative, the T-SN provides the SCG measConfig and/or execution conditions together with the conditional reconfiguration(s) that is configured by the T-SN. The T-SN then sends the SCG measConfig and/or execution conditions together with the conditional reconfiguration (associated to the conditional reconfiguration) to the MN, e.g., in S-NODE ADDITION REQUEST ACK, and to the UE 10.
   When the UE 10 performs the mobility procedure to a candidate cell, it may use the SCG measConfig and the execution conditions received from T-SN.
      If full configuration: the UE 10 may delete the S-SN SCG measConfig, and may replace with the SCG measConfig received from T-SN.
      If delta configuration: the UE 10 may keep the SCG measConfig received by the S-SN and, using the delta SCG measConfig from the T-SN, may generate the valid SCG measConfig valid.
Measurement configurations and execution conditions received after the mobility execution:
   When the UE 10 moves to the T-SN, the UE 10 may store the associated SCG measConfig and execution conditions.
   The UE 10 may indicate to the T-SN the SCG measConfig and execution condition, e.g., in RRCReconfigurationComplete.
   The T-SN may perform, if needed, a measurement reconfiguration and update the SCG measConfig by using e.g. RRCReconfiguration

Embodiments herein refer to a first network node operating as a Master Node (MN), e.g. having a Master Cell Group (MCG) configured to the UE; that MN can be a gNodeB, or a Central Unit gNodeB (CU-gNB) or an eNodeB, or a Central Unit eNodeB (CU-eNB), or any network node and/or network function. Embodiments herein also refer to a second network node operating as a Secondary Node (SN), or Source Secondary Node (S-SN) e.g. having a Secondary Cell Group (SCG) pre-configured (i.e. not connected) to the UE; that SN can be a gNodeB, or a Central Unit gNodeB (CU-gNB) or an eNodeB, or a Central Unit eNodeB (CU-eNB), or any network node and/or network function. Notice that MN, S-SN and T-SN may be from the same or different Radio Access Technologies, and possibly be associated to different Core Network nodes.

The text often refers to a Secondary Node (SN), or target SN (T-SN). This is equivalent to say this is a target candidate SN, or a network node associated to a target candidate PSCell that is being configured. If the UE would connect to that cell, transmissions and receptions with the UE would be handled by that node if the cell is associated to that node.

The text says that a cell resides in a node, e.g., a target candidate cell resides in the S-SN or the T-SN. That is equivalent to say that a cell is managed by the node, or is associated to the node, or associated with the node, or that the cell belongs to the node, or that the cell is of the node.

SN-initiated CPC corresponds to a procedure wherein the S-SN for a UE configured with MR-DC determines to configure CPC. Upon determining, the S-SN selects, e.g., based on reported measurements, one or more target candidate cells (target candidate PSCell(s)) wherein at least one cell is associated to the S-SN, and at least another cell is associated to a neighbour SN. It can be said that if all target candidate cells are associated to the S-SN that is an SN-initiated intra-SN CPC, which may be referred as the Release 16 solution. It can be said that if at least one target candidate cell is associated to a neighbour SN that is an SN-initiated inter-SN CPC, which may be referred as a Release 17 solution.

The document refers to a candidate SN, or SN candidate, or an SN, as the network node, e.g., gNodeB, that is prepared during the CPA procedure and that can create an RRC Reconfiguration message with an SCG configuration, e.g., RRCReconfiguration**, to be provided to the UE and stored, with an execution condition, wherein the UE only applies the message upon the fulfillment of the execution condition. That candidate SN is associated to one or multiple PSCell candidate cell(s) that the UE can be configured with. The UE may then execute the condition and accesses one of these candidate cells, associated to a candidate SN that becomes the SN or simply the SN after execution, i.e., upon fulfillment of the execution condition.

The document refers to a CPC configuration and procedures, like CPC execution, most of the time to refer to the procedure from the UE perspective. Other terms may be considered as synonyms such as conditional reconfiguration, or Conditional Configuration, since the message that is stored and applied upon fulfillment of a condition is an RRCReconfiguration or RRCConnectionReconfiguration. Terminology wise, one could also interpret conditional handover (CHO) in a broader sense, also covering CPA procedures. The document refers to a Conditional SN Change most of the time to refer to the procedure from the UE perspective, to refer to procedures between network nodes wherein a node requests a target candidate SN (which may be the same as the S-SN or a neighbour SN) to configure a CPC for at least one of its associated cells (cell associated to the target candidate SN).

The document may use CPAC as a way to refer to either a CPA or a CPC.

The document refers to a neighbour SN and a S-SN as different entities, though both could be a target candidate SN for CPC.

The configuration of CPC may be done using the same information elements (IE) as conditional handover, which may be called at some point as conditional configuration or conditional reconfiguration. The principle for the configuration is the same with configuring triggering/execution condition(s) and a reconfiguration message to be applied when the triggering condition(s) are fulfilled. The configuration IEs from TS 38.331 v. 17.0.0:

```
  ConditionalReconfiguration
  The IE ConditionalReconfiguration is used to add, modify and release the
configuration of conditional configuration.
  ConditionalReconfiguration information element
  -- ASN1START
  -- TAG-CONDITIONALRECONFIGURATION-START
```

| | |
|---|---|
| ConditionalReconfiguration-r16 ::= | SEQUENCE { |
| attemptCcondReconfig-r16 | ENUMERATED {true} |

OPTIONAL, -- Need N

| | |
|---|---|
| condConfigToRemoveList-r16 | CondConfigToRemoveList-r16 |

OPTIONAL, -- Need N

| | |
|---|---|
| condConfigToAddModList-r16 | CondConfigToAddModList-r16 |

```
OPTIONAL, -- Need N
    ...
  }
```

| | |
|---|---|
| CondConfigToRemoveList-r16 ::= | SEQUENCE (SIZE (1.. |

```
maxNrofCondCells)) OF CondConfigId-r16
  -- TAG-CONDITIONALRECONFIGURATION-STOP
  -- ASN1STOP
```

```
ConditionalReconfiguration field descriptions
  condConfigToAddModList
  List of the configuration of candidate SpCells to be added or modified for CHO or
CPC.
  condConfigToRemoveList
  List of the configuration of candidate SpCells to be removed. When the network
removes the stored conditional configuration for a candidate cell, the network releases the
measIDs associated to the condExecutionCond if it is not used by the condExecutionCond
of other candidate cells.
```

- CondConfigId
The IE CondConfigId is used to identify a CHO or CPC configuration.
CondConfigId information element
-- ASN1START
-- TAG-CONDCONFIGID-START
CondConfigId-r16 ::= INTEGER (1.. maxNrofCondCells)
-- TAG-CONDCONFIGID-STOP
-- ASN1STOP
- CondConfigToAddModList

The IE CHO-Config ToAddModList concerns a list of conditional configurations to add or modify, with for each entry the cho-ConfigId and the associated condExecutionCond and condRRCReconfig.

```
  CondConfigToAddModList information element
  -- ASN1START
  -- TAG-CONDCONFIGTOADDMODLIST-START
```

| | |
|---|---|
| CondConfigToAddModList-r16 ::= | SEQUENCE (SIZE (1.. |

maxNrofCondCells)) OF CondConfigToAddMod-r16

| | |
|---|---|
| CondConfigToAddMod-r16 ::= | SEQUENCE { |
| condConfigId-r16 | CondConfigId-r16, |
| condExecutionCond-r16 | SEQUENCE (SIZE (1..2)) OF |

MeasId OPTIONAL, -- Need S

| | |
|---|---|
| condRRCReconfig-r16 | OCTET STRING (CONTAINING |

```
RRCReconfiguration) OPTIONAL, -- Need S
    ...
  }
  -- TAG-CONDCONFIGTOADDMODLIST-STOP
  -- ASN1STOP
```

```
CondConfigToAddMod field descriptions
  condExecutionCond
  The execution condition that needs to be fulfilled in order to trigger the execution of
a conditional configuration. The field is mandatorily present when a condConfigId is being
added. Otherwise, when the condRRCReconfig associated to a condConfigId is being
modified it is optionally present and the UE uses the stored value if the field is absent.
  condRRCReconfig
  The RRCReconfiguration message to be applied when the condition(s) are fulfilled.
The field is mandatorily present when a condConfigId is being added. Otherwise, when the
condExecutionCond associated to a condConfigId is being modified it is optionally present
and the UE uses the stored value if the field is absent.
```

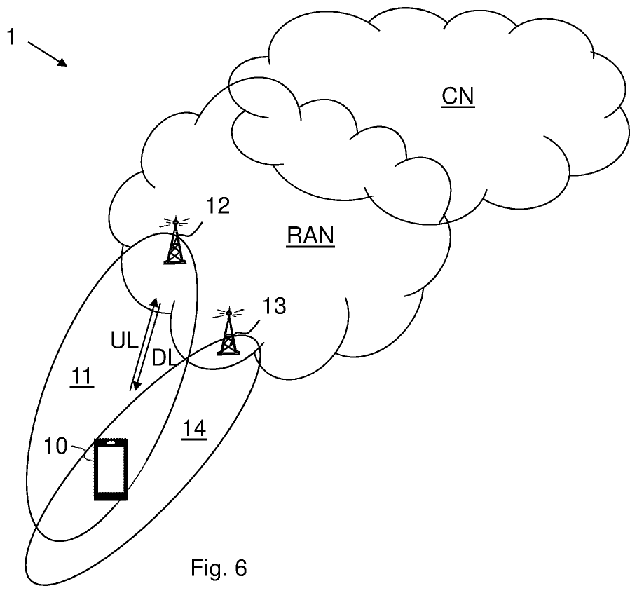

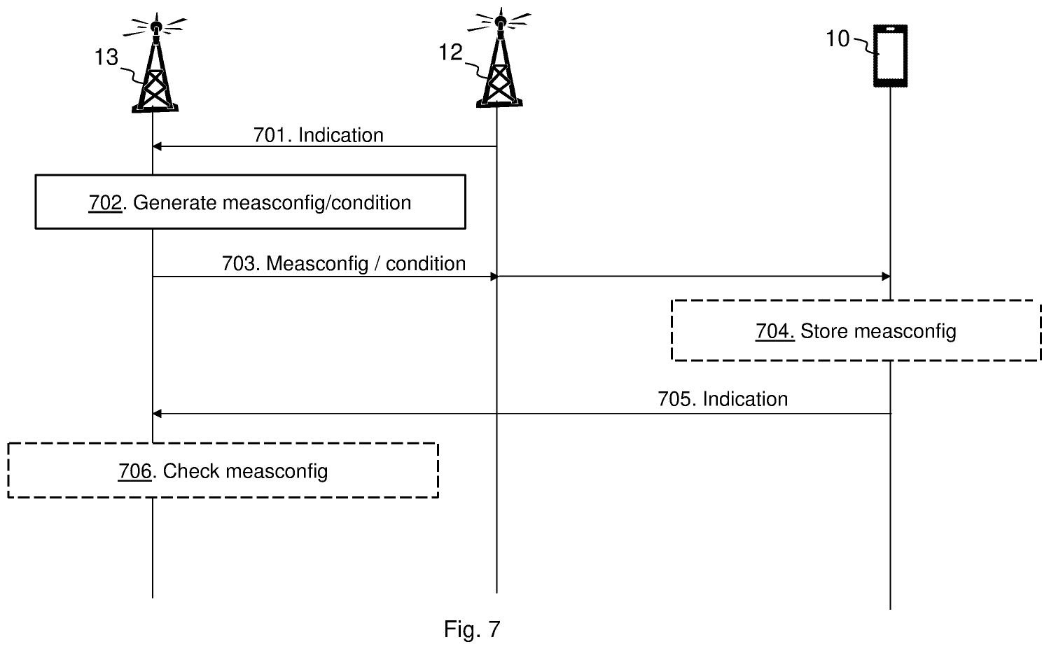

FIG. 7 is a combined signalling and flowchart scheme according to some embodiments herein focusing on the estimated signal quality.

Action 701. The first network node 12 may indicate to the second network node 13 to initiate a generation of measurement configuration and related condition configuration.

Action 702. The second network node 13 generates measurement configuration and related condition configuration. The generated measurement configuration and related condition configuration may be a full set or a delta set of a complete measurement configuration and related condition configuration.

Action 703. The generated measurement configuration and/or related condition configuration, such as execution condition, is reported to the UE 10 and/or the first network node 12.

Action 704. The UE 10 may store the measurement configuration and related condition configuration for the candidate second network node 13.

Action 705. The UE 10 may transmit to the second network node 13, an indication of the stored measurement configuration and related condition configuration for the candidate second network node 13.

Action 706. The second network node 13 may check the received indication with its own measurement configuration and related condition configuration for the candidate second network node 13. If needed, the second network node 13 may update the measurement configuration and related condition configuration for the UE 10.

Embodiments herein include different methods to allow the UE 10, which keeps stored the conditional reconfigurations, to have the correct measurement configurations and execution conditions once the mobility procedure to a candidate cell is executed (e.g. after a successful random access procedure to a target SpCell).

The correct measurement configurations and execution conditions can be received by the UE 10, from the T-SN(s), before or after the execution of the mobility procedure.

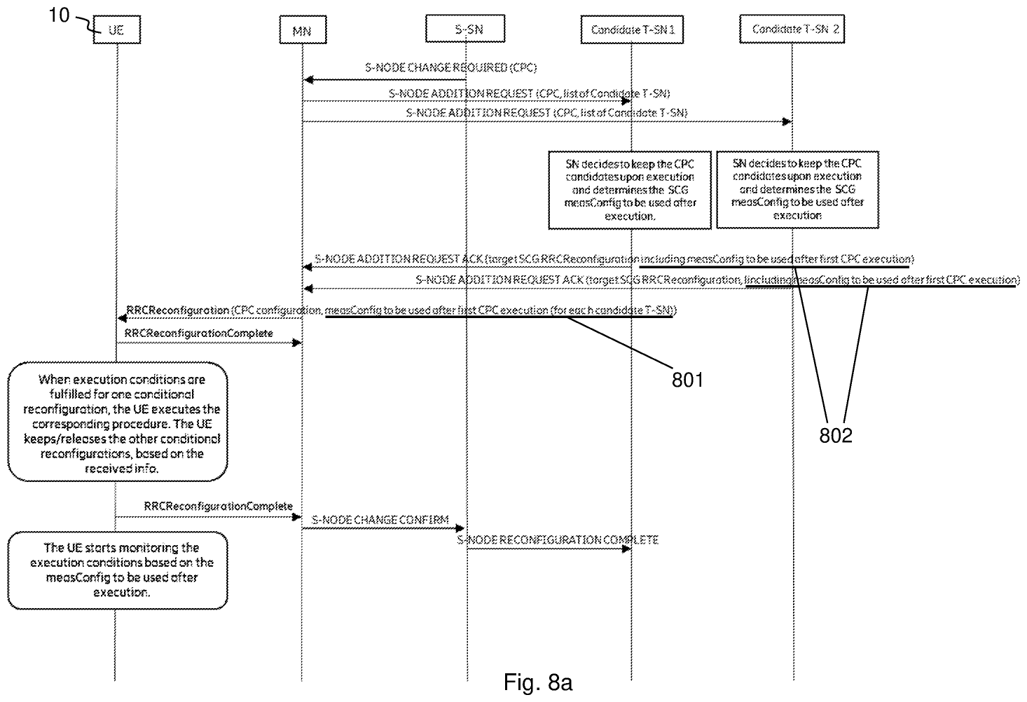

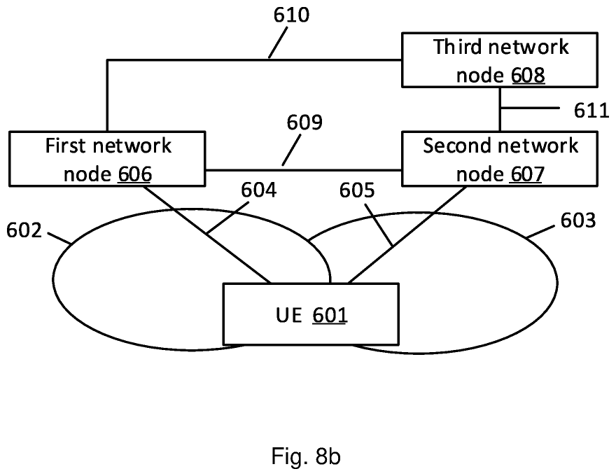

Candidate SCG measConfig received before execution of mobility procedure (full/delta configuration) see FIG. 8a.

FIG. 8a shows a Candidate SCG measConfig received before execution of mobility procedure.

In the first embodiment, the MN, being an example of the first network node 12, may indicate to each candidate T-SN, being examples of the second network node 13, to generate a full or delta SCG measConfig and execution conditions for each CPC candidate that will be kept by the UE 10. This is based on an indication from the MN in the S-NODE ADDITION REQUEST.

In one example, the MN does not include the S-SN SCG measConfig in the S-NODE ADDITION REQUEST to the candidate T-SN. This may imply that the T-SN shall generate a full SCG measConfig.

In another example, the MN includes the S-SN SCG measConfig, and the related execution conditions, in the S-NODE ADDITION REQUEST to the candidate T-SN. This may serve as an indication that the T-SN shall generate a delta SCG measConfig.

In yet another example, the MN can indicate if the T-SN shall generate a full or a delta SCG measConfig, by including an explicit indication in the S-NODE ADDITION REQUEST.

In one embodiment, the T-SN generates the SCG measConfig and execution conditions for each CPC candidate based on the indication from the MN.

Alternatively, the T-SN always generates an SCG measConfig to be used for measuring conditions on a conditional reconfiguration that is included in another conditional reconfiguration and that is only activated once the first conditional reconfiguration has been executed. In this solution, the MN may not need to include any indication to the T-SN.

In one alternative, the SCG measConfig is a full configuration. The T-SN generates the SCG measConfig and the related execution conditions, determining or knowing the other candidate T-SNs and/or candidate PSCells.

In another alternative, the SCG measConfig is a delta configuration. The T-SN generates the delta SCG measConfig by taking into account the S-SN SCG measConfig and the related execution conditions, received in the S-NODE ADDITION REQUEST.
The T-SN may keep all the execution conditions, that is, the MeasIDs numbers, and may modify the related MeasObjectNR, ReportConfigNR. For instance, the T-SN may use an empty MeasObjectNR for the candidate cells that need to be released or deactivated by the UE.
The T-SN may keep the execution conditions of the candidate cells that need to be stored by the UE 10, eventually the related MeasObjectNR, ReportConfigNR can be modified, and may release all the other execution conditions.

In another embodiment, the T-SN includes the newly generated (full or delta) SCG measConfig and execution conditions in the conditional reconfigurations of the candidates, e.g. in the RRCReconfiguration** via the MN, see action 801. The T-SN may explicitly indicate if the SCG measConfig is a full or delta configuration.

In another embodiment, when the UE 10 performs the mobility procedure to a candidate cell, e.g., at a successful RA procedure to a target SpCell, and applies the conditional reconfiguration, the UE 10 may use the SCG measConfig and execution conditions received for that conditional reconfigurations.

In one alternative, if the SCG measConfig is a full configuration, the UE 10 may delete the S-SN SCG measConfig and all the execution conditions (as in legacy Rel. 17) and may directly apply the SCG measConfig (and the execution conditions) received from the T-SN.

In another alternative, if the SCG measConfig is a delta configuration, the UE 10 may keep the S-SN SCG measConfig received and, apply the delta SCG measConfig from the T-SN, and may generate the SCG measConfig valid in T-SN. That means that the T-SN builds the delta configuration based on the measConfig that the UE 10 applies when the conditional reconfiguration is executed, i.e., the T-SN builds the delta on top of its own SCG measConfig that the T-SN had prepared within the conditional reconfiguration.

In one alternative to the above embodiments, see action 802, the T-SN provides the SCG measConfig and/or execution conditions together with the conditional reconfiguration(s) that is configured by the T-SN. The T-SN may then send the SCG measConfig together with the conditional reconfiguration, possibly with an association to the conditional reconfiguration, to the MN, e.g., in S-NODE ADDITION REQUEST ACK, and to the UE 10. In one alternative, which may be combined with the previous alternative, the T-SN may send the execution conditions, for the other conditional reconfiguration(s) that is/are to be stored by the UE after execution of the conditional reconfiguration that is here provided by the T-SN, together with this conditional reconfiguration, possibly with an association to the conditional reconfiguration, to the MN, e.g., in S-NODE ADDITION REQUEST ACK, and to the UE 10.

In one example for the embodiments, the SCG measConfig corresponds to the SCG measurement configuration associated to conditional reconfigurations, i.e., not the parts of the SCG measConfig that correspond to other SCG measurement configuration.

SCG measConfig received after execution of mobility procedure.

In one embodiment, when the UE 10 performs the mobility procedure to a candidate cell, e.g., at a successful RA procedure to a target SpCell, the UE 10 keeps the associated SCG measConfig and execution conditions, received by the S-SN.

Alternatively, the UE 10 may keep part of the SCG measConfig, e.g., the SCG measConfig that is used in execution conditions, but the UE may delete the SCG measConfig that is used for other measurements which are not related to any execution condition.

In one example, the UE 10 may release the other configurations, e.g. the other conditional reconfigurations, or may deactivate them.

In another embodiment, the UE 10 may indicate to the new S-SN, the SCG measConfig and execution condition that the UE 10 had stored from the previous S-SN. For example, this is indicated by including the stored SCG measConfig and execution conditions in the RRCReconfigurationComplete that is sent to the new S-SN or in another RRC message.

In one embodiment, the new S-SN can update, if needed, the SCG measConfig (e.g. the MeasObjectNR and ReportConfigNR) by performing a measurement reconfiguration (e.g. via an RRCReconfiguration).

In one alternative, the new S-SN may provide to the UE 10 a new full configuration of SCG measConfig.

In another alternative, the new S-SN may provide to the UE 10 a delta SCG measConfig.

### System Overview.

FIG. 8b illustrates entities used for the description of the solution. The UE 601, being an example of the UE 10, may be a wireless terminal, such as a cellular smartphone. The UE 601 is sometimes configured for multi-radio dual connectivity (MR-DC).

The UE 601 is connected via a first cell group 602 to a first network node 606 over a radio interface 604. When the UE 601 is configured in MR-DC, the UE 601 is also connected via a second cell group 603 to a second network node 607 over a radio interface 605.

The first network node 606, sometimes known as a Master Node, MN, controls the first cell group 602, sometimes known as the Master Cell Group, MCG. The first cell group 602 is configured with a main cell, such as a PCell, and optionally multiple additional cells, such as SCells, in a carrier aggregation, CA, configuration.

When the UE 601 is configured in MR-DC, the second network node 607, sometimes known as a Secondary Node, SN, controls the second cell group 603, sometimes also known as the Secondary Cell Group, SCG. The second cell group 603 is configured with a main cell, such as a Primary SCG Cell, PSCell, and optionally multiple additional cells, such as secondary cells, SCells, in a CA configuration. The second network node 607 is connected with the first network node 606 over an interface 609. The first network node 606 and the second network node 607 are examples of the first network node 12.

A third network node 608, being an example of the second network node 13, is in the context of a mobility procedure or a conditional configuration sometimes also referred to as a target Secondary Node, T-SN, a target MN, T-MN, a target gNB or a target eNB. It controls a third cell group (not illustrated in the figure), including a cell during a mobility procedure in the context of a mobility procedure or a conditional configuration sometimes referred to as a candidate target cell or a target cell. The third network node 608 is connected to the first network node 606 over an interface 610 and may also be connected to the second network node 607 over an interface 611.

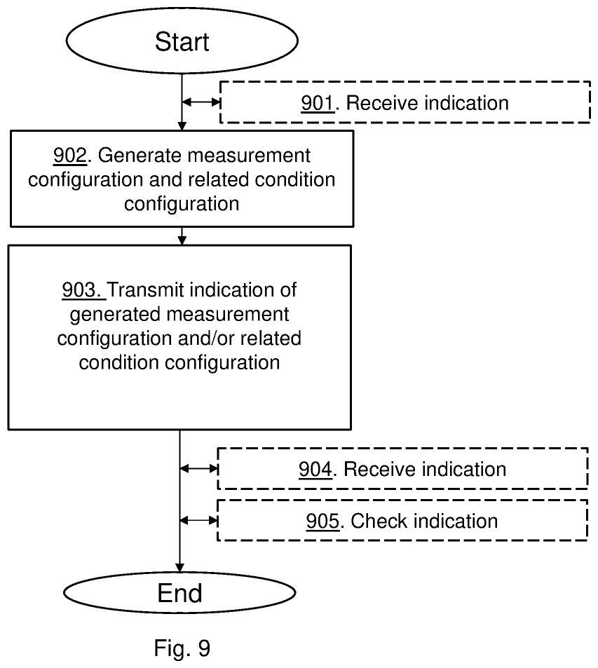

The method actions performed by the second network node 13 for handling communication of the UE 10 in the communication network 1 according to embodiments herein will now be described with reference to a flowchart depicted in FIG. 9. The actions do not have to be taken in the order stated below, but may be taken in any suitable order. Dashed boxes indicate optional features. The second network node may be a target secondary network node.

Action 901. The second network node 13 may receive an indication from the first network node 12 an indication to generate a full set or a delta set of measurement configuration and related condition configuration for the second network node 13.

Action 902. The second network node 13 generates a measurement configuration, such as a SCG measconfig, and a related condition configuration such as an execution condition of a condition configuration. The related conditional configuration may comprise an execution condition that needs to be fulfilled in order to trigger an execution of the related conditional configuration.

Action 903. The second network node 13 transmits to the first network node 12 and/or the UE 10, an indication of the generated measurement configuration and/or the related condition configuration. The related conditional configuration may comprise the execution condition, and the measurement configuration may comprise the SCG measurement configuration. The SCG measurement configuration and/or the execution condition may be transmitted with, or included in, a conditional reconfiguration of the second network node. The indication may be a value, an index, a flag or similar.

Action 904. The second network node 13 may then receive an indication from the UE 10, wherein the indication indicates stored measurement configuration and related condition configuration at the UE 10.

Action 905. The second network node 13 may check that the indicated measurement configuration and related condition configuration at the UE 10 is correct for the second network node 13.

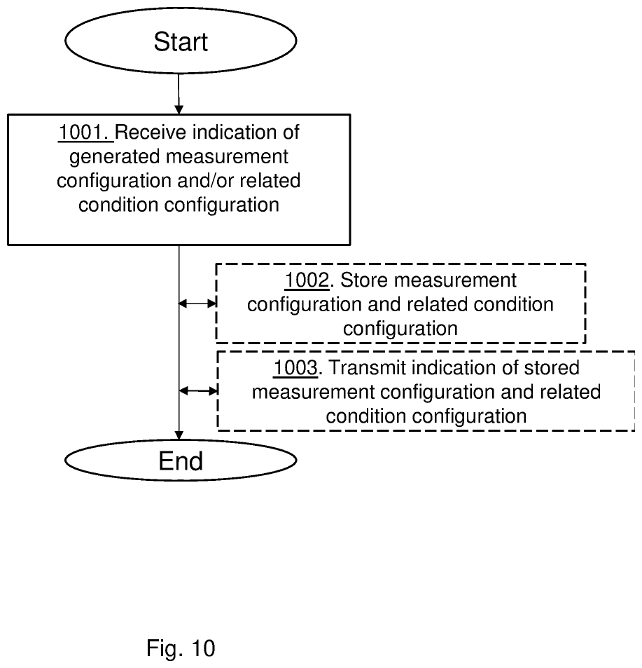

The method actions performed by the UE 10 for handling communication in the communication network 1 according to embodiments herein will now be described with reference to a flowchart depicted in FIG. 10. The actions do not have to be taken in the order stated below but may be taken in any suitable order. Dashed boxes indicate optional features.

Action 1001. The UE 10 receives the indication of the generated measurement configuration and/or the related condition configuration for the second network node 13. The indication may be a value, an index, a flag or similar. The related conditional configuration may comprise an execution condition that needs to be fulfilled in order to trigger an execution of the related conditional configuration. The second network node may be a target secondary node.

Action 1002. The UE 10 may then store the indicated measurement configuration and related condition configuration for the second network node 13.

Action 1003. The UE 10 may further transmit to the second network node 13 or any other network node, the indication of the stored measurement configuration and related condition configuration for the second network node 13.

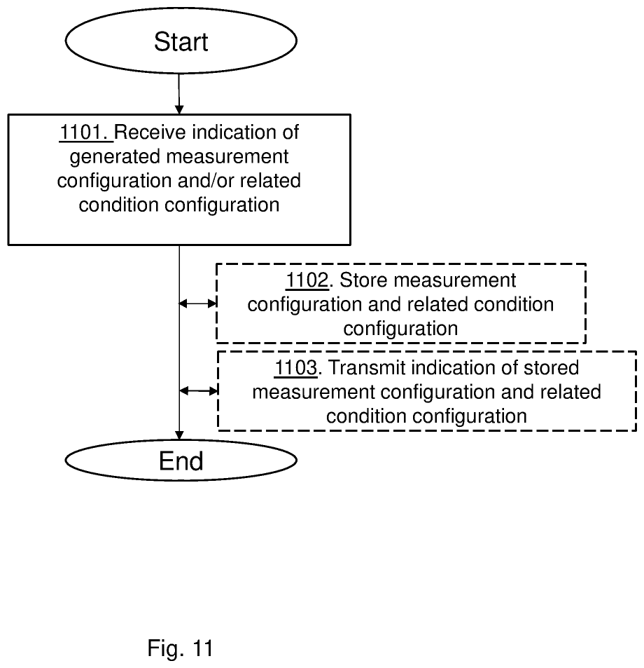

The method actions performed by the first network node 12 for handling communication in the communication network 1 according to embodiments herein will now be described with reference to a flowchart depicted in FIG. 11. The actions do not have to be taken in the order stated below but may be taken in any suitable order. Dashed boxes indicate optional features. The second network node may be a target secondary network node and the first network node may be a master node or a source secondary node.

Action 1101. The first network node 12 receives the indication of the generated measurement configuration and/or the related condition configuration for the UE 10 in a cell of the second network node 13. The indication may be a value, an index, a flag or similar. The related conditional configuration may comprise an execution condition that needs to be fulfilled in order to trigger an execution of the related conditional configuration.

Action 1102. The first network node 12 may then store the indicated measurement configuration and the related condition configuration for the second network node 13.

Action 1103. The first network node 12 may further transmit to the UE 10 or any other network node, the indication of the stored measurement configuration and the related condition configuration for the second network node 13.

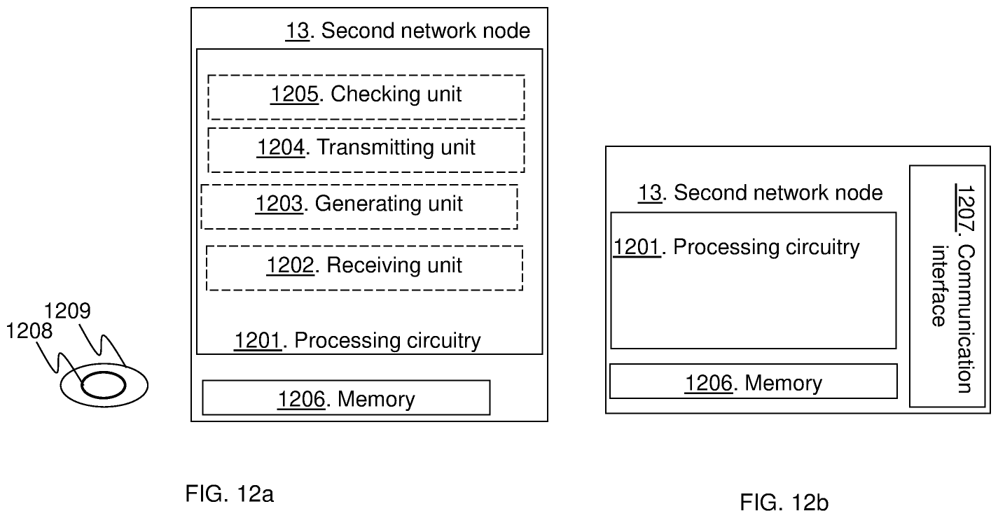

FIGS. 12a-b are schematic overviews of the second network node 13 for handling communication in the communication network 1 according to embodiments herein. The second network node may be a target secondary node.

The second network node 13 may comprise processing circuitry 1201, e.g., one or more processors, configured to perform the methods herein.

The second network node 13 may comprise a receiving unit 1202, such as a receiver and/or transceiver. The second network node 13, the processing circuitry 1201 and/or the receiving unit 1202 may be configured to receive the indication to generate a full set or a delta set of measurement configuration and the related condition configuration for the second network node 13. The indication may comprise a flag or a value.

The second network node 13 may comprise a generating unit 1203. The second network node 13, the processing circuitry 1201 and/or the generating unit 1203 is configured to generate the measurement configuration, such as a SCG measconfig, and the related condition configuration such as an execution condition of a condition configuration. The related conditional configuration may comprise an execution condition that needs to be fulfilled in order to trigger an execution of the related conditional configuration.

The second network node 13 may comprise a transmitting unit 1204, such as a transmitter and/or transceiver. The second network node 13, the processing circuitry 1201 and/or the transmitting unit 1204 is configured to transmit the indication of the generated measurement configuration and/or the related condition configuration. The indication may be a value, an index, a flag or similar. The related conditional configuration may comprise the execution condition, and the measurement configuration may comprise the SCG measurement configuration. The SCG measurement configuration and/or the execution condition may be transmitted with, or included in, a conditional reconfiguration of the second network node.

The second network node 13, the processing circuitry 1201 and/or the receiving unit 1202 may be configured to receive the indication from the UE 10, wherein the indication indicates stored measurement configuration and related condition configuration at the UE 10.

The second network node 13 may comprise a checking unit 1205. The second network node 13, the processing circuitry 1201 and/or the checking unit 1205 may be configured to check that the indicated measurement configuration and the related condition configuration at the UE 10 is correct for the second network node 13.

The second network node 13 may comprise a memory 1206. The memory 1206 comprises one or more units to be used to store data on, such as data packets, measurement configuration and related condition configuration, parameter(s), indices, configuration, indications, flags, thresholds, measurements, events and applications to perform the methods disclosed herein when being executed, and similar. Furthermore, the second network node 13 may comprise a communication interface 1207, see FIG. 12b, comprising such as a transmitter, a receiver, a transceiver and/or one or more antennas.

The methods according to the embodiments described herein for the second network node 13 are respectively implemented by means of e.g. a computer program product 1208 or a computer program, see FIG. 12a, comprising instructions, i.e., software code portions, which, when executed on at least one processor, cause the at least one processor to carry out the actions described herein, as performed by the second network node 13. The computer program product 1208 may be stored on a computer-readable storage medium 1209, see FIG. 12a, e.g. a disc, a universal serial bus (USB) stick or similar. The computer-readable storage medium 1209, having stored thereon the computer program product, may comprise the instructions which, when executed on at least one processor, cause the at least one processor to carry out the actions described herein, as performed by the second network node 13. In some embodiments, the computer-readable storage medium may be a transitory or a non-transitory computer-readable storage medium. Thus, embodiments herein may disclose a second network node for handling communication of a UE in the communication network, wherein the second network node 13 comprises processing circuitry and a memory, said memory comprising instructions executable by said processing circuitry whereby said second network node is operative to perform any of the methods herein.

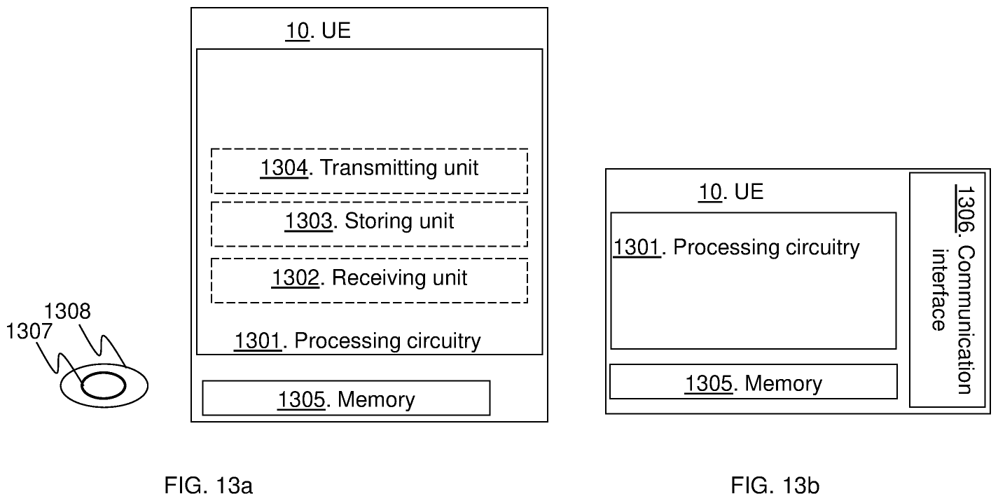

FIGS. 13a-b are schematic overviews of the UE 10 for handling communication in the communication network 1 according to embodiments herein.

The UE 10 may comprise processing circuitry 1301, e.g. one or more processors, configured to perform the methods herein.

The UE 10 may comprise a receiving unit 1302, e.g., the receiver, or transceiver. The UE 10, the processing circuitry 1301, and/or the receiving unit 1302 is configured to receive from the first network node 12 or the second network node 13, the indication of the generated measurement configuration and/or the related condition configuration for the second network node 13. The indication may be a value, an index, a flag or similar. The related conditional configuration may comprise an execution condition that needs to be fulfilled in order to trigger an execution of the related conditional configuration. The second network node may be a target secondary node.

The UE 10 may comprise a storing unit 1303, e.g., a writer, a memory. The UE 10, the processing circuitry 1301, and/or the storing unit 1303 may be configured to store the indicated measurement configuration and the related condition configuration for the second network node 13.

The UE 10 may comprise a transmitting unit 1304, e.g., a writer, a transmitter or transceiver. The UE 10, the processing circuitry 1301, and/or the transmitting unit 1304 may be configured to transmit to the second network node 13 or any other network node, the indication of the stored measurement configuration and the related condition configuration for the second network node 13.

The UE 10 may comprise a memory 1305. The memory 1305 comprises one or more units to be used to store data on, such as data packets, measurement configuration and related condition configuration, parameter(s), indices, configuration, indications, measurements, events and applications to perform the methods disclosed herein when being executed, and similar. Furthermore, the UE 10 may comprise a communication interface 1306, see FIG. 13b, such as comprising a transmitter, a receiver, a transceiver and/or one or more antennas.

The methods according to the embodiments described herein for the UE 10 are respectively implemented by means of e.g. a computer program product 1307 or a computer program, see FIG. 13a, comprising instructions, i.e., software code portions, which, when executed on at least one processor, cause the at least one processor to carry out the actions described herein, as performed by the UE 10. The computer program product 1307 may be stored on a computer-readable storage medium 1308, see FIG. 13a, e.g. a disc, a universal serial bus (USB) stick or similar. The computer-readable storage medium 1308, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium. Thus, embodiments herein may disclose a UE 10 for handling communication in the communication network, wherein the UE 10 comprises processing circuitry and a memory, said memory comprising instructions executable by said processing circuitry whereby said UE 10 is operative to perform any of the methods herein.

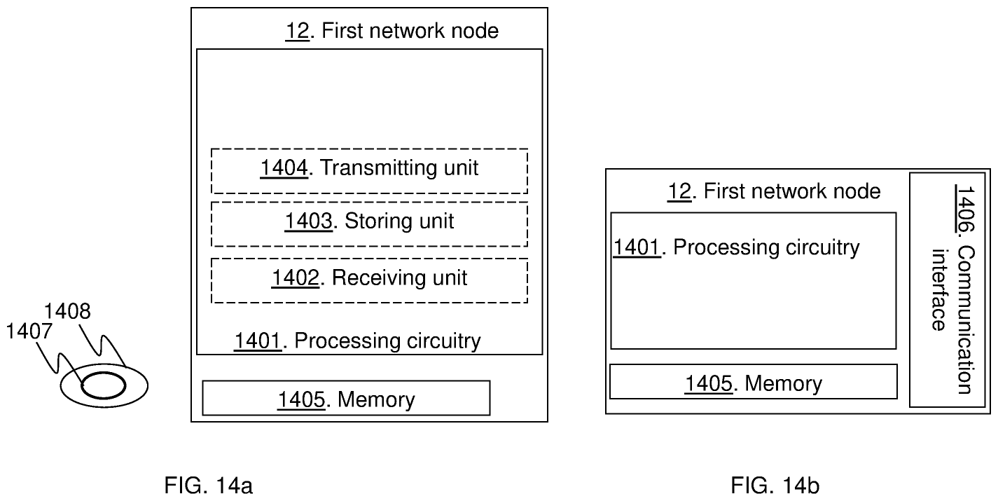

FIGS. 14a-b are schematic overviews of the first network node 12, e.g. MN or primary secondary network node, for handling communication in the communication network 1 according to embodiments herein. The second network node may be a target secondary network node and the first network node may be a master node or a source secondary node.

The first network node 12 may comprise processing circuitry 1401, e.g. one or more processors, configured to perform the methods herein.

The first network node 12 may comprise a receiving unit 1402, e.g., the receiver, or transceiver. The first network node 12, the processing circuitry 1401, and/or the receiving unit 1402 is configured to receive from the second network node 13, the indication of the generated measurement configuration and/or the related condition configuration for the UE 10 in a cell of the second network node 13. The indication may be a value, an index, a flag or similar. The related conditional configuration may comprise an execution condition that needs to be fulfilled in order to trigger an execution of the related conditional configuration.

The first network node 12 may comprise a storing unit 1403, e.g., a writer, a memory. The first network node 12, the processing circuitry 1401, and/or the storing unit 1403 may be configured to store the indicated measurement configuration and the related condition configuration for the second network node 13.

The first network node 12 may comprise a transmitting unit 1404, e.g., a writer, a transmitter or transceiver. The first network node 12, the processing circuitry 1401, and/or the transmitting unit 1404 may be configured to transmit to the UE or any other network node, the indication of the stored measurement configuration and the related condition configuration for the second network node 13.

The first network node 12 may comprise a memory 1405. The memory 1405 comprises one or more units to be used to store data on, such as data packets, measurement configuration and related condition configuration, parameter(s), indices, configuration, indications, measurements, events and applications to perform the methods disclosed herein when being executed, and similar. Furthermore, the first network node 12 may comprise a communication interface 1406, see FIG. 14b, such as comprising a transmitter, a receiver, a transceiver and/or one or more antennas.

The methods according to the embodiments described herein for the first network node 12 are respectively implemented by means of e.g. a computer program product 1407 or a computer program, see FIG. 14a, comprising instructions, i.e., software code portions, which, when executed on at least one processor, cause the at least one processor to carry out the actions described herein, as performed by the first network node 12. The computer program product 1407 may be stored on a computer-readable storage medium 1408, see FIG. 14a, e.g. a disc, a universal serial bus (USB) stick or similar. The computer-readable storage medium 1408, having stored thereon the computer program product, may comprise the instructions which, when executed on at least one processor, cause the at least one processor to carry out the actions described herein, as performed by the first network node 12. In some embodiments, the computer-readable storage medium may be a transitory or a non-transitory computer-readable storage medium. Thus, embodiments herein may disclose a first network node 12 for handling communication in the communication network, wherein the first network node 12 comprises processing circuitry and a memory, said memory comprising instructions executable by said processing circuitry whereby said first network node 12 is operative to perform any of the methods herein.

In some embodiments a more general term “network node” is used and it can correspond to any type of radio-network node or any network node, which communicates with a wireless device, wired device and/or with another network node. Examples of network nodes are, router, modem, server, UE, NodeB, master (M) eNB, secondary(S) eNB, a network node belonging to Master cell group (MCG) or Secondary cell group (SCG), base station (BS), multi-standard radio (MSR) radio node such as MSR BS, eNodeB, gNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), internet of things (IoT) capable device, machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

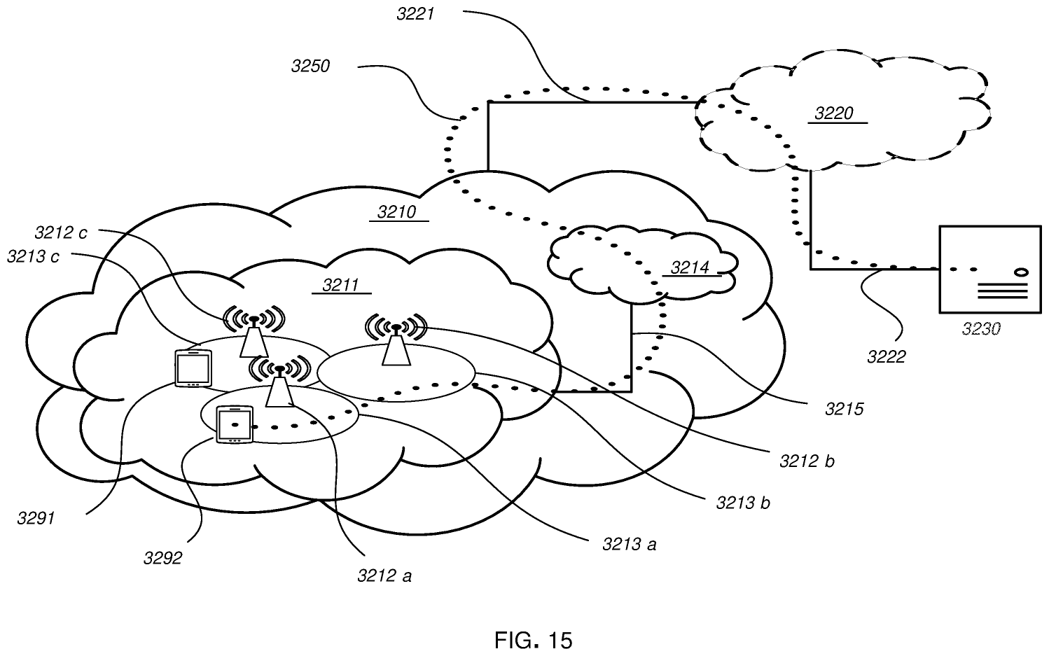

With reference to FIG. 15, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the network nodes 12, 13 herein, each defining a corresponding coverage area 3213a, 3213b, 3213c. Each base station 3212a, 3212b, 3212c is connectable to the core network 3214 over a wired or wireless connection 3215. A first UE 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 15 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

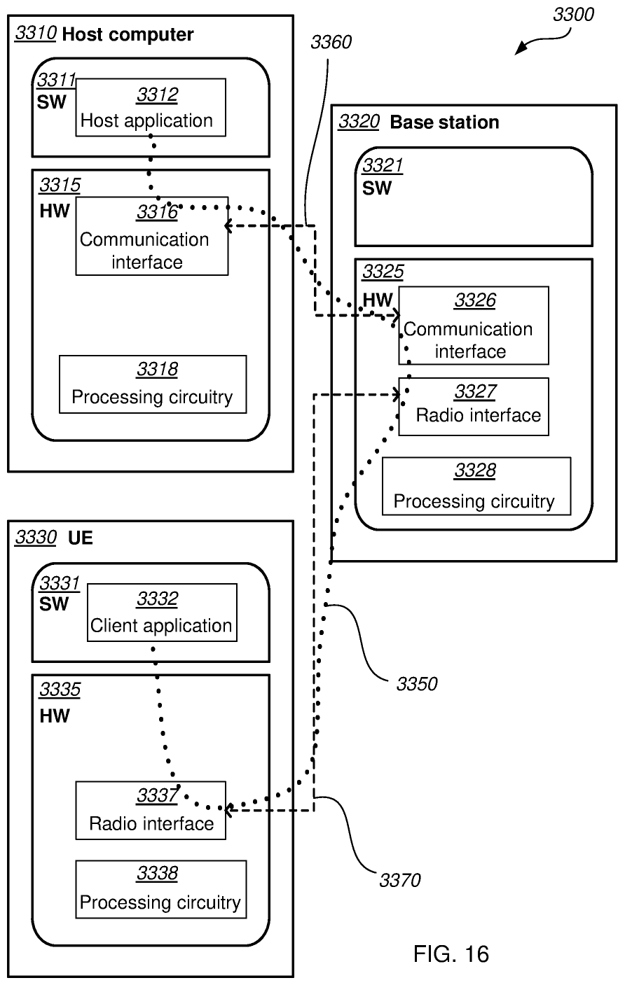

Example implementations, in accordance with an embodiment, of the UE, base station and host computer discussed in the preceding paragraphs will now be described with reference to FIG. 16. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 16) served by the base station 3320. The communication interface 3326 may be configured to facilitate a connection 3360 to the host computer 3310. The connection 3360 may be direct or it may pass through a core network (not shown in FIG. 16) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 16 may be identical to the host computer 3230, one of the base stations 3212a, 3212b, 3212c and one of the UEs 3291, 3292 of FIG. 15, respectively. This is to say, the inner workings of these entities may be as shown in FIG. 16 and independently, the surrounding network topology may be that of FIG. 15.

In FIG. 16, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing, e.g., on the basis of load balancing consideration or reconfiguration of the network.

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since the UEs have correct measurement configuration and related condition configuration and thereby provide benefits such as improved efficiency and may lead to better performance such as better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

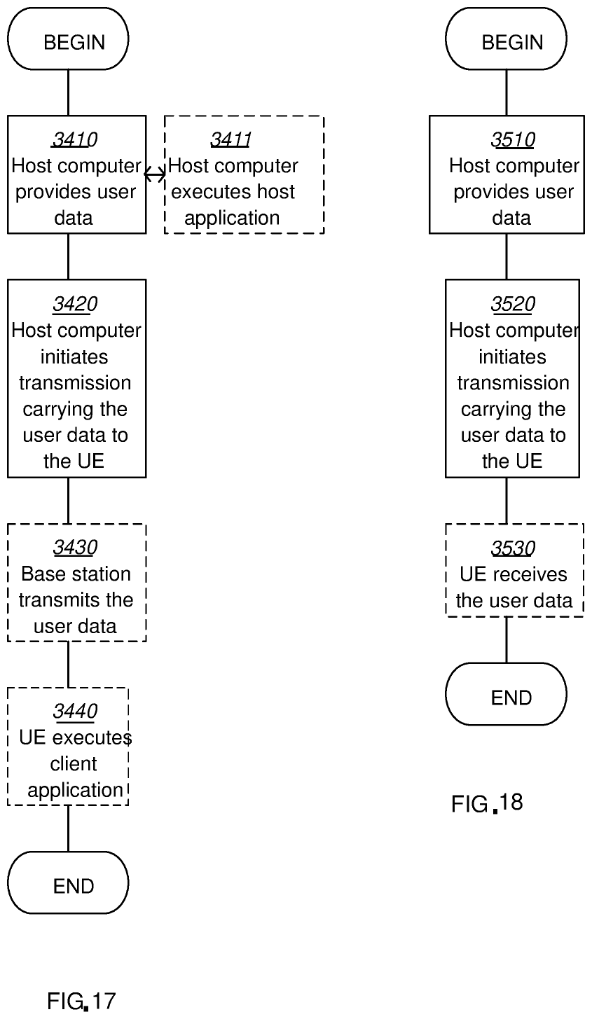

FIG. 17 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 17 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 18 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 18 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

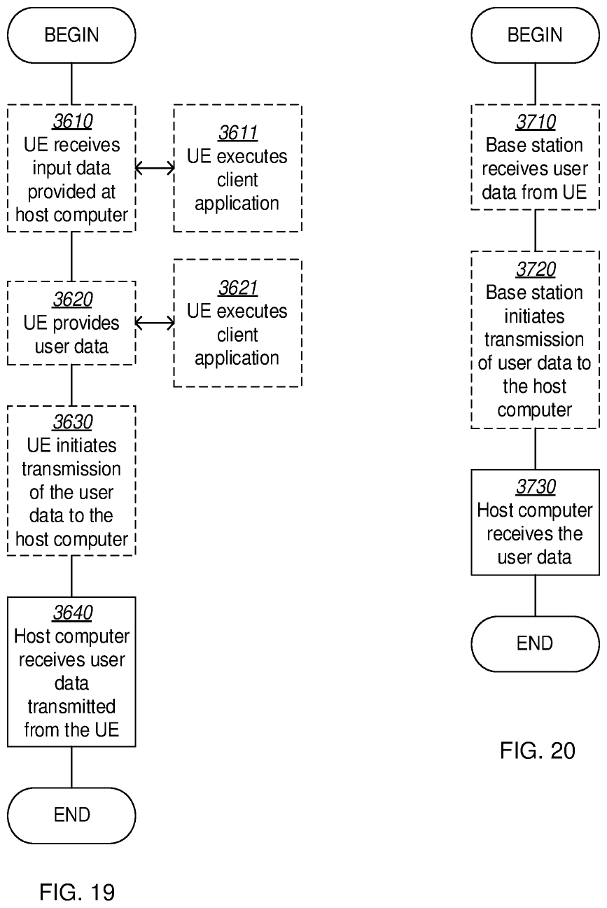

FIG. 19 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 19 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third step 3630, transmission of the user data to the host computer. In a fourth step 3640 of the method, the host computer receives the user data transmitted from the UE, in accordance with the teachings of the embodiments described throughout this disclosure.

FIG. 20 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 20 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

Modifications and other embodiments of the disclosed embodiments will come to mind to one skilled in the art having the benefit of the teachings presented in the foregoing descriptions and the associated drawings. Therefore, it is to be understood that the embodiment(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

Abbrevations

| | |
|---|---|
| 5GC or 5GCN | 5G core network |
| ACK | Acknowledgement |
| AGC | Automatic Gain Control |
| AMF | Access and Mobility management Function |
| AP | Application Protocol |
| BSR | Buffer Status Report |
| BWP | Bandwidth Part |
| C-RNTI | Cell Radio Network Temporary Identifier |
| CA | Carrier Aggregation |
| CE | Control Element |
| CHO | Conditional Handover |
| CN | Core Network |
| CPA | Conditional PSCell Addition |
| CPC | Conditional PSCell Change |
| CP | Control Plane |
| CQI | Channel Quality Indicator |
| C-RNTI | Cell Radio Network Temporary Identifier |
| CSI | Channel State Information |
| DC | Dual Connectivity |
| DCI | Downlink Control Information |
| DL | Downlink |
| DRB | Data Radio Bearer |
| eNB | (EUTRAN) base station |
| E-RAB | EUTRAN Radio Access Bearer |
| E-UTRA | Evolved Universal Terrestrial Radio Access |
| E-UTRAN | Evolved Universal Terrestrial Radio Access Network |
| FDD | Frequency Division Duplex |
| gNB | NR base station |
| GTP-U | GPRS Tunneling Protocol - User Plane |
| IE | Information Element |
| IP | Internet Protocol |
| LTE | Long Term Evolution |
| MCG | Master Cell Group |
| MAC | Medium Access Control |
| MAC CE | MAC Control Element |
| MeNB | Master eNB |
| MgNB | Master gNB |
| MN | Master Node |
| MR-DC | Multi-Radio Dual Connectivity |
| NACK | Negative Acknowledgement |
| NAS | Non Access Stratum |
| NG-RAN | Next Generation Radio Access Network |
| Ng-eNB | Next Generation Evolved Node B |
| NR | New Radio |
| PDCP | Packet Data Convergence Protocol |
| PCell | Primary Cell |
| PCI | Physical Cell Identity |
| PDCCH | Physical Downlink Control Channel |
| PHR | Power headroom report |
| PSCell | Primary Secondary Cell (in LTE) |
| | or Primary SCG Cell (in NR) |
| PUCCH | Physical Uplink Control Channel |
| PUSCH | Physical Uplink Shared Channel |
| RACH | Random Access Channel |
| RAT | Radio Access Technology |
| RB | Radio Bearer |
| RLC | Radio Link Control |
| RLF | Radio Link Failure |
| RRC | Radio Resource Control |
| SCell | Secondary Cell |
| SCG | Secondary Cell Group |
| SCTP | Stream Control Transmission Protocol |
| SeNB | Secondary eNB |
| SgNB | Secondary gNB |
| SINR | Signal to Interference plus Noise Ratio |
| SN | Secondary Node |
| SR | Scheduling Request |
| SRB | Signaling Radio Bearer |
| S-SN | Source Secondary Node |
| SUL | Supplementary uplink |
| SpCell | Special Cell, the primary cell of a |
| | master or secondary cell group |
| TAT | Time Alignment Timer |
| TDD | Time Division Duplex |
| TEID | Tunnel Endpoint IDentifier |
| TNL | Transport Network Layer |
| T-SN | Target Secondary Node |
| UCI | Uplink Control Information |
| UDP | User Datagram Protocol |
| UPF | User Plane Function |
| UE | User Equipment |
| UL | Uplink |
| UL-SCH | Uplink Shared Channel |
| UP | User Plane |
| URLLC | Ultra Reliable Low Latency Communication |
| X2 | Onterface between base stations |

1.-40. (canceled)

41. A second network node for handling communication of a user equipment (UE) in a communication network, wherein the second network node comprises:
a communication interface; and
processing circuitry configured to:
generate a measurement configuration and a related condition configuration; and
transmit, to a first network node and/or the UE, an indication of the generated measurement configuration and/or the related condition configuration.

42. The second network node according to claim 41, wherein the processing circuitry is configured to receive an indication from the first network node to generate a full set or a delta set of measurement configuration and the related condition configuration for the second network node.

43. The second network node according to claim 41, wherein the related conditional configuration comprises an execution condition that needs to be fulfilled in order to trigger an execution of the related conditional configuration.

44. The second network node according to claim 41, wherein the indication comprises a value, an index, or a flag.

45. The second network node according to claim 41, wherein the processing circuitry is configured to receive an indication from the UE, wherein the indication indicates stored measurement configuration and related condition configuration at the UE.

46. The second network node according to claim 45, wherein the processing circuitry is configured to check that the indicated measurement configuration and related condition configuration at the UE is correct for the second network node.

47. The second network node according to claim 41, wherein the second network node is a target secondary network node.

48. A user equipment (UE) for handling communication in a communication network, wherein the UE comprises:
a communication interface; and
processing circuitry configured to receive an indication of a generated measurement configuration and/or a related condition configuration for a second network node.

49. The UE according to claim 48, wherein the processing circuitry is configured to store the indicated measurement configuration and the related condition configuration for the second network node.

50. The UE according to claim 49, wherein the processing circuitry is configured to transmit to the second network node or any other network node, an indication of the stored measurement configuration and the related condition configuration for the second network node.

51. The UE according to claim 49, wherein the related conditional configuration comprises an execution condition that needs to be fulfilled in order to trigger an execution of the related conditional configuration.

52. The UE according to claim 49, wherein the indication comprises a value, an index, or a flag.

53. The UE according to claim 49, wherein the second network node is a target secondary node.

54. A first network node for handling communication in a communication network, wherein the first network node comprises:
a communication interface; and
processing circuitry configured to receive an indication of a generated measurement configuration and/or a related condition configuration for a user equipment (UE) in a cell of a second network node.

55. The first network node according to claim 54, wherein the processing circuitry is configured to store the indicated measurement configuration and the related condition configuration for the second network node.

56. The first network node according to claim 55, wherein the processing circuitry is configured to transmit, to the UE or any other network node, an indication of the stored measurement configuration and the related condition configuration for the second network node.

57. The first network node according to claim 54, wherein the related conditional configuration comprises an execution condition that needs to be fulfilled in order to trigger an execution of the related conditional configuration.

58. The first network node according to claim 54, wherein the indication comprises a value, an index, or a flag.

59. The first network node according to claim 54, wherein the second network node is a target secondary network node and the first network node is a master node or a source secondary node.

60. A method performed by a second network node for handling communication of a user equipment (UE) in a communication network, the method comprising:
generating a measurement configuration and a related condition configuration; and
transmitting, to a first network node and/or the UE, an indication of the generated measurement configuration and/or the related condition configuration.

61. A method performed by a user equipment (UE) for handling communication in a communication network, the method comprising:
receiving an indication of a generated measurement configuration and/or a related condition configuration for a second network node.

62. The method according to claim 61, further comprising storing the indicated measurement configuration and the related condition configuration for the second network node.

63. The method according to claim 61, further comprising transmitting, to the second network node or any other network node, an indication of the stored measurement configuration and the related condition configuration for the second network node.

64. The method according to claim 61, wherein the related conditional configuration comprises an execution condition that needs to be fulfilled in order to trigger an execution of the related conditional configuration.

65. The method according to claim 61, wherein the indication comprises a value, an index, or a flag.

66. A method performed by a first network node for handling communication in a communication network, the method comprising:
receiving an indication of a generated measurement configuration and/or a related condition configuration for a user equipment (UE) in a cell of a second network node.
